(19) United States
(12) Patent Application Publication
(10) Pub. No.: US 2006/0235733 A1
(43) Pub. Date: Oct. 19, 2006

(54) System and method for providing integration of service-oriented architecture and Web services

(76) Inventor: Eric A. Marks, West Newbury, MA (US)

Correspondence Address: HAYES SOLOWAY PC, 175 Canal Street, Manchester, NH, 03101, US

(21) Appl. No.: 11/104,901

(22) Filed: Apr. 13, 2005

(51) Int. Cl. G06F 17/50

(52) U.S. Cl. 705/7

(57) ABSTRACT

A system and method for providing integration of service-oriented architecture (SOA) is provided. Generally, the method comprising the steps of: identifying SOA drivers, thereby determining matters that are driving the company to integrate the SOA and Web services into the company; developing a business initiative roadmap, thereby performing an analysis of current and planned business initiatives and projects of the company, and an analysis of current and potential services that will be required to implement or support the business initiatives during the providing integration of the SOA and Web services; developing an SOA technology roadmap, thereby determining necessary SOA enabling technical solutions that can be implemented to support the developed business initiative roadmap; and prioritizing and sequencing the business initiative roadmap and the SOA technology roadmap, thereby synchronizing the business initiatives and Web service initiatives with implementation of the supporting SOA technical solutions determined during the step of developing the SOA technology roadmap.

### FIELD OF THE INVENTION

The present invention is generally related to business and information technology, and more particularly is related to the process of planning, architecting and implementing Service-Oriented Architecture (SOA) and Web services.

### BACKGROUND OF THE INVENTION

With continued advancements in information technology (IT), more and more technology solutions are available to assist in solving business and IT challenges, such as information security, internal integration, business-to-business integration (B2Bi), hardware and software optimization, asset re-use, business process management (BPM), IT and business agility, and overall better IT management. These technology solutions may include software solutions that are typically included in an information technology (IT) architecture of a company. Examples of such software solutions may include, for instance, Web servers, Application servers, J2EE architecture, Microsoft .NET framework, open source software solutions, legacy business applications, commercial software applications and business suites, messaging backbones, systems management solutions, software and application development tools and integrated development environments (IDE), and identity management/security solutions and more. Of course, there are many other technological resources that are currently used by companies in their technology IT architecture.

Over time, typical IT architectures have accumulated layers of complexity in the form of legacy hardware, software and application applications, silos of technologies, silos of business information, and a rigid structure that has inhibited flexible business processes and more efficient IT delivery processes to internal business customers. A common fact of IT architectures is that these legacy systems do not go away. Rather, they are layers to which more modern platforms and applications are added. These distinct layers represent accumulated technology complexity over time. Because of this accumulated complexity in IT architectures, an ongoing challenge for business and IT executives has been integrating these disparate technologies, platforms, and applications so that needed information is accessible to business consumers during the conduct of business processes. The impact of this problem was exposed during the 1990s with the rise of client-server architectures, and again with the rapid adoption of the Internet by businesses and consumers worldwide, which resulted in an n-Tier architectural paradigm. Integration of these technological resources and disparate architectures and applications is unfortunately quite inconvenient, very complex, costly and difficult. In fact, it is often the case that additional software is purchased for the purpose of allowing integration of portions of technological resources already used by a company. In fact, the business and IT integration problem spawned an entire new category of software solutions, known as Enterprise Application Integration (EAI). These integration suites enjoyed great hype and promise with the impact of the Internet on IT and business, as well as With the increased requirement to integration applications and legacy systems to provide unified access to the information assets of the business.

While addressing integration of technological resources is inconvenient, difficult and costly, lack of integration limits business success and information technology efficiency. The need for integration has outweighed the costs required to do so, and thus integration initiatives continue to be pursued by organizations. Enterprise Application Integration (EAI) solutions used to solve integration challenges are known to suffer a number of drawbacks, most notably that they are proprietary, expensive, architectural rigid and inflexible, and deploy as hub-and-spoke architectures, which can inhibit performance and scalability. These EAI drawbacks are widely acknowledged, and backlash against proprietary integration solutions resulted in alternative approaches based on widely agreed upon industry standards. The industry standards of interest here include, at least, the suite of Internet standards advocated by the World Wide Web Consortium (W3C), such as XML, TCP/IP, HTTP, FTP, SMTP, and others.

Separately, a new set of standards were being jointly developed by Microsoft and IBM to facilitate application integration and platform independent application functionality (known as “services”, or Web services). Web services are application functions that have well-defined, published and standards-compliant interfaces based on Extensible Markup Language (XML), and are discoverable by developers and users by virtue of having been published to a searchable services registry. The standards devised by Microsoft and IBM include the following: SOAP, a messaging and envelope standards, Web Services Description Language (WSDL), a services interface definition standard, and Universal Description, Discovery, and Integration (UDDI), a services registry specification standards. These standards are based on XML, and build upon the previous standards of the Internet, which were mentioned above.

The advent of Web services based on industry-agreed standards poses a clear threat to proprietary integration strategies and vendor solution, primarily the EAI integration suites. This is because Web services are based on industry standards and they are very easy and fast to create and implement using existing and recent development tools that support Service-Oriented Architecture (SOA) and Web services. As a result, most EAI solutions today are rapidly adding Web services support into their products through acquisitions as well as through new features and functions.

Competing vendor approaches, development tools and Web services, and SOA solutions have created interoperability issues despite adherence to the industry standards. This is in part due to variations in the interpretation of how to implement the standards. Issues to be addressed during integration include, for example whether an EAI Simple Object Access Protocol (SOAP) stack will be compatible with an application server SOAP stack, whether the EAI SOAP stack will implement SOAP messaging in a compatible fashion to the application server SOAP stack (e.g., document messaging versus Remote Procedure Call (RPC) style messaging), and do both software platforms support the Web Services-Interoperability (WS-I) Basic Profile.

As is known by those having ordinary skill in the art, SOA is a way of making application functionality available through shared services discoverable on a network. SOAs have traditionally depended on proprietary messaging middleware that often erases efficiency gains made. Examples are CORBA and COM/DCOM, which did implement SOA concepts with the exception that the available services were constrained to those proprietary platforms and implementations. Fortunately, due to industry-wide standardization of XML, SOAP, WSDL, and UDDI, services can be published, discovered, and invoked using interfaces that are supported by competing vendors.

An SOA is more than a collection of services and Web services. An SOA is also the technical architecture required to publish, discover, operate, and manage services in support of enterprise applications. Flexibility of an SOA also benefits the business through faster application development and lowered costs by allowing hardware and software components to be reused. Applications developed this way can even be of higher quality than those developed independently because the components are pre-tested and the Web services interfaces have already been proven.

Of course, it is possible to implement an SOA without Web services. In fact, an SOA does not require Web services if there are “services” that can be discovered, shared and re-used. Specifically, the concept has been around since the rise of object-oriented technology, taking the form of RPC middleware solutions such as Microsoft RPC and Java Remote Method Invocation (RMI). These solutions implement a synchronous client-server communications model, in which one application acts as a client and another as a server. Unfortunately, compared to Web services, this model has two major disadvantages. First, synchronous operations can slow applications down because the client remains idle until the server has completed its request. Second, RPC-style solutions are typically proprietary and will not interoperate across platforms. As a result, a problem exists in finding a single RPC solution that works with all the required programming tools and computing platforms at an affordable price.

Message-Oriented Middleware (MOM) goes some way toward solving both of the above-mentioned RPC problems, however, it introduces new problems. MOM solutions, such as WebSphere MQ, by IBM, SonicMQ, by Sonic Software, MSMQ, by Microsoft, and Rendezvous, by TIBCO Software, implement asynchronous peer-to-peer communications, allowing an application to continue its normal processing, while waiting for a response from another application. This approach is typically associated with loosely coupled connections, which allow greater independence regarding exactly how a message is processed. The downside of MOM solutions is that they are often more complex to implement than basic RPC. MOM solutions are also expensive and proprietary.

With regard to implementing an SOA with Web services, designing an SOA is complicated by immaturity of Web services and the related standards. In fact, even the concept of “services” is often misunderstood, and Web services as a subset of potentially available services adds to the confusion. As an example, enterprises still grappling with XML are bombarded by continued standards volatility. Vendors from previously separate markets are working to provide SOA solutions, where each vendor is claiming to offer the most important component of an SOA, whether it be Web services management, security, development tools, or the Enterprise Services Bus (ESB) and related middleware that enables SOA through available services. While some of these solutions are critical in an SOA, others will depend on existing IT architecture and goals of an implementing business. Therefore, while an SOA and use of Web services will assist in providing integration of technological resources and enable efficiency, implementation of an SOA and Web services can, in and of itself, be a difficult procedure unless implemented properly.

Thus, a heretofore unaddressed need exists in the industry to address the aforementioned deficiencies and inadequacies.

### SUMMARY OF THE INVENTION

Embodiments of the present invention provide a system and method for integrating SOA, where integrating SOA includes providing consulting and educational services approaches to understanding, planning, designing, modeling, architecting, and implementing SOA and Web services into a company. In this regard, one embodiment of such a method, among others, can be broadly summarized by the following steps: identifying SOA drivers, thereby determining matters that are driving the company to integrate the SOA and Web services into the company; developing a business initiative roadmap, thereby performing an analysis of current and planned business initiatives and projects of the company, and an analysis of current and potential services that will be required to implement or support the business initiatives during the providing integration of the SOA and Web services; developing an SOA technology roadmap, thereby determining necessary SOA enabling technical solutions that can be implemented to support the developed business initiative roadmap; and prioritizing and sequencing the business initiative roadmap and the SOA technology roadmap, thereby synchronizing the business initiatives and Web service initiatives with implementation of the supporting SOA technical solutions determined during the step of developing the SOA technology roadmap.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating a general purpose computer capable of performing many of the functions described herein.

FIG. 2 is a flowchart illustrating a method of developing an SOA playbook, in accordance with a first exemplary embodiment of the invention FIG. 3 is a flowchart further illustrating steps that may be taken during implementation of the strategic path.

FIG. 4 is a flowchart further illustrating steps that may be taken during identifying SOA drivers.

FIG. 5 is a flowchart further illustrating the step of developing a business initiative roadmap.

FIG. 6 is a flowchart further illustrating the step of performing an IT architecture assessment.

FIG. 7 is a schematic diagram further illustrating the step of developing an SOA technology roadmap.

FIG. 8 is a flowchart further illustrating the step of prioritizing and sequencing SOA technology roadmaps.

FIG. 9 is a flowchart further illustrating the step of developing the SOA governance model and policies.

FIG. 10 is a flowchart further illustrating the step of developing SOA scorecards and metrics.

### DETAILED DESCRIPTION

The present system and method provides for integrating an SOA and Web services, wherein integrating includes understanding, planning, designing and architecting, and implementing an SOA and Web services. The present description provides for understanding, planning, designing and architecting, and implementing SOA and Web services within a company via use of a developed SOA playbook and modification of the SOA playbook in accordance with changes in the company business strategy, IT strategy or IT architecture. It should be noted that the SOA playbook is a general SOA implementation guideline that may be followed by different companies to assist in the understanding, planning, designing and architecting, and implementation of SOA and Web services. Modification and customization of the SOA playbook over time by the company ensures that proper integration of the SOA and Web services is maintained throughout the life of the company.

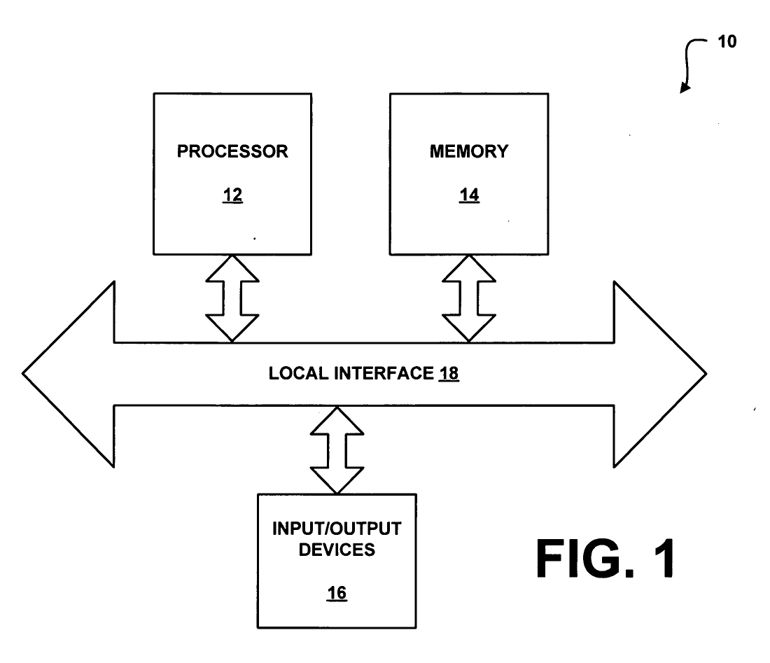

It should be noted that, although many of the steps described herein may be performed by more or more individuals, many of the steps described herein may also be performed via use of software stored within a memory that is executed by a suitable instruction execution system. As an example, many of the steps described herein may be implemented in software, as an executable program, and executed by a special or general purpose digital computer, such as a personal computer (PC; IBM-compatible, Apple-compatible, or otherwise), workstation, minicomputer, or mainframe computer. A block diagram providing an example of a general-purpose computer that can implement steps described herein is shown in FIG. 1. In FIG. 1, the computer is denoted by reference numeral 10.

Referring to FIG. 1, the computer 10 includes a processor 12, memory 14, and one or more input and/or output (I/O) devices 16 (or peripherals) that are communicatively coupled via a local interface 18. The local interface 18 can be, for example but not limited to, one or more buses or other wired or wireless connections, as is known in the art. The local interface 18 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 12 is a hardware device for executing software, particularly that stored in memory 14. The processor 12 can be any custom made or commercially available processor, a central processing unit (CPU), an auxiliary processor among several processors associated with the computer 10, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 14 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 14 may incorporate electronic, magnetic, optical, and/or other types of storage media. Note that the memory 14 can have a distributed architecture, where various components are situated remote from one another, but can be accessed by the processor 12. The software in memory 14 may include one or more separate programs, each of which comprises an ordered listing of executable instructions for implementing logical functions.

If implemented in hardware, as in an alternative embodiment, the steps can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Developing and Using the SOA Playbook

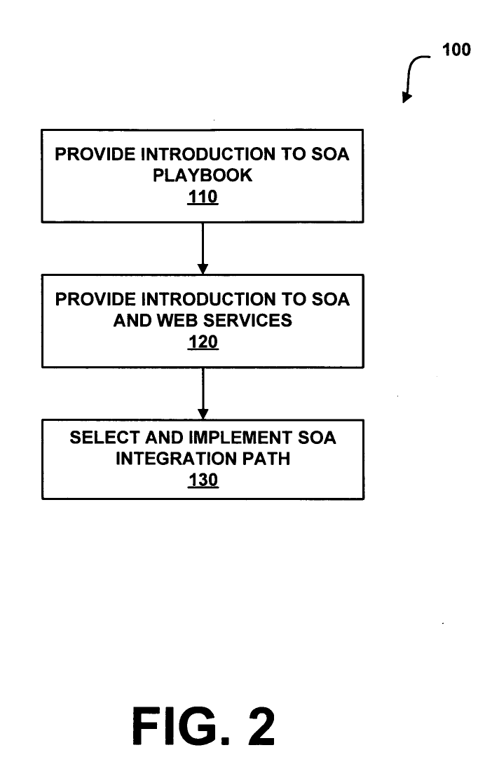

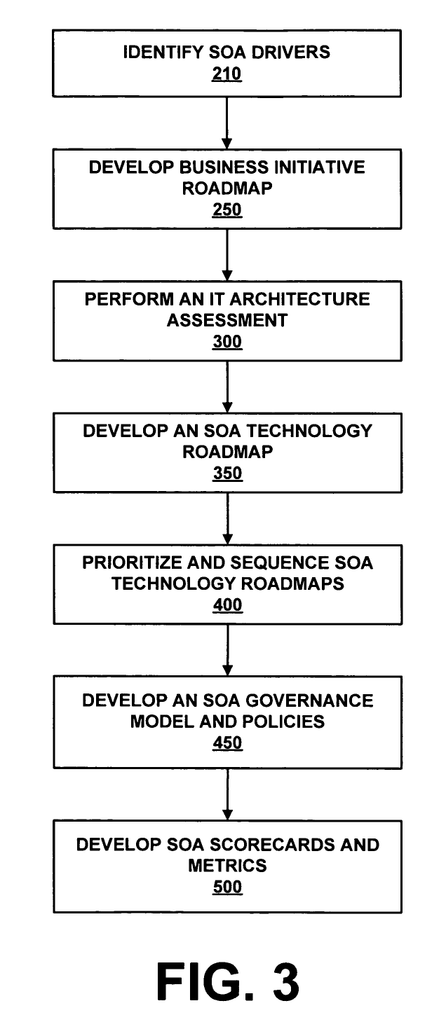

FIG. 2 is a flowchart 100 illustrating a method of developing and using the SOA playbook, in accordance with the first exemplary embodiment of the invention. It should be noted that any process descriptions or blocks in flowcharts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

Referring to FIG. 2, an introduction to the SOA playbook is first provided (block 110). The following describes examples of steps that may be included while introducing the SOA playbook for purposes of explaining how to use the SOA playbook. Specifically, prior to use of the SOA playbook it may be beneficial to explain the purpose of the SOA playbook to those that will be directly involved in understanding, planning, designing and architecting, and implementing SOA and Web services into the company. As an example, it may be explained to a team of individuals that will be implementing the SOA playbook, generally how the SOA playbook will assist in enabling the team to understand, plan, design and architect, and implement SOA and Web services into the company. In addition, a general overview of how to use the SOA playbook provides an explanation of how using the SOA playbook provides tailoring of the SOA playbook specific to the company seeking to understand, plan, design and architect, and implement SOA and Web services.

An introduction to SOA and Web services may also be provided (block 120). The introduction to SOA and Web services comprises introducing basic definitions and terminology associated with SOA and Web services to the user of the SOA playbook. The following describes examples of steps that may be included while providing an introduction to SOA and Web services. It should be noted that performance of the following steps depends upon experience of the individual whom is going to understand, plan, design and architect, and implement SOA and Web services within the company. As an example, if the individual is very familiar with SOA and Web services, the following steps may not be necessary.

A first step that may be performed is providing a basic introduction to SOA. During the basic introduction to SOA, the basic definition of an SOA may be discussed. A second step may then be to provide an introduction to services, including Web services. During providing an introduction to Web services, different Web services development and modeling tools may be introduced and defined, as well as introducing SOA enablement solutions and infrastructure. Examples of Web services development and modeling tools may include Integrated Development Environments (IDEs) (with application servers), XML modeling and testing tools, and Web services diagnostics tools. In addition, examples of SOA enablement solutions and infrastructure include SOA runtime solutions, Web services management/SOA visibility solutions, service registries, ESB/messaging platform, and Web services security.

A third step that may be performed is describing to those that will be directly involved in understanding, planning, designing and architecting, and implementing the SOA and Web services into the company that use and modification of the SOA playbook over time will result in their company being a service oriented business. In addition, providing an explanation of what a service oriented business is may be beneficial.

A fourth step that may be performed when providing an introduction to SOA and Web services is providing to those that will be directly involved in understanding, planning, designing and architecting, and implementing the SOA and Web services into the company an introduction to different SOA foundation standards (i.e., industry standards) that may be applied while understanding, planning, designing and architecting, and implementing the SOA and Web services into the company. An example of an SOA industry standard may include XML. In addition, examples of XML based protocols, languages, and registries may include, but are not limited to, SOAP, WSDL, and UDDI, respectively. Of course, other SOA and Web services standards may be introduced.

A fifth step that may be performed when providing an introduction to SOA and Web services is introducing SOA second-generation standards. During introduction to SOA second-generation standards, a select few standards directly applicable to the company understanding, planning, designing and architecting, and implementing SOA and Web services are introduced. Knowledge of these standards will become apparent during developing of other portions of the SOA playbook 100. Examples of these second-generation standards include, but are not limited to, WS-BPEL, or business process execution language for Web services (BPEL4WS), which is a workflow and business process management standard, WS-Coordination, WS-Security, WS-Transaction, WS-ReliableMessaging, WS-Addressing, WS-Policy, WS-PolicyAssertions, WS-PolicyAttachments. It should be noted that these are examples of the second-generation standards that have augmented the foundation standards of XML, SOAP, WSDL and UDDI.

A sixth step that may be performed when providing an introduction to SOA and Web services is introducing SOA core technology solutions (i.e., software solutions). Specifically, during the introduction of SOA core technology solutions, software solutions that are generally capable of enabling understanding, planning, designing and architecting, and implementation of the SOA and Web services are reviewed.

A seventh step that may be performed when providing an introduction to SOA and Web services is introducing SOA core solutions, also known as SOA solutions that will be required by the company. Examples of SOA core solutions may include, but are not limited to, Web services management solutions, services registries, Web services security solutions, and ESB.

Web services management solutions provide service monitoring, alerting, reliable message routing, service failover, intelligent routing, services visibility, enforce Web services policies, and provide Service Level Agreement (SLA) enforcement. In addition, services registries provide a repository for services descriptions, WSDL documents, URIs or pointers to available services, manage metadata for services, manage consumer and provider information by roles, manage SOA policies, and interface with ESB and/or WSM solutions for failover and services backup purposes.

Web service security solutions contain multiple classes of solutions that define and enforce a Web service security model for internal and external services, both at design and at runtime. WSM solutions will typically integrate with identity management and single sign-on solutions, and enforce the various security standards as an organization implements them per a defined security policy. In addition, an ESB provides messaging infrastructure services for the SOA, including message routing, content-based routing, transformation services, synchronous and asynchronous message support, legacy system adapters, and Web services broker capability (or active intermediary services).

An eighth step that may be performed when providing an introduction to SOA and Web services is introducing SOA extended functions. The SOA extended functions are extended technology solutions that may eventually be needed by the company with the implementation of the core functions. Examples of SOA extended technology solutions include, but are not limited to, XML accelerators, federated identity management for establishing a trust domain that can extend from one company to multiple other companies (i.e., a manner of implementing Web security), development tools (i.e., software) to be used to further develop Web services introduced with integration of the SOA and Web services into the company, EAI platforms, and asset re-use repository which is known to be meta-data catalogs of software assets that can be reused in a business such as, but not limited to, components, objects, test scripts, and related software artifacts.

Returning to FIG. 2, an SOA understanding, planning, designing and architecting, and implementation path is then selected and implemented 130. SOA understanding, planning, designing and architecting, and implementation paths that may be selected from include a strategic path, a tactical path, and a dual path. The strategic path, which is described in detail herein, is focused on the SOA. Alternatively, a tactical path is focused on Web services, while the dual path begins with a blended SOA strategy and one or more tactical Web services projects.

To elaborate on the tactical path, the tactical path entails performing the steps of: identifying Web services pilot projects; implementing enough SOA enablement infrastructure to deliver success; measuring Web services ROI and promoting the success; and implementing Web services with an eye toward SOA. The tactical path is for organizations that are in their early SOA and Web services adoption phases, where they must first accumulate some understanding, knowledge and experience with Web services before considering a more strategic approach to SOA and Web services for their enterprise. In addition, elaborating on the dual path, the dual path entails performing the steps of: performing lightweight SOA strategy and planning; defining a preliminary SOA governance model; defining simple SOA scorecards and metrics; identifying first Web services projects under SOA initiative; and delivering a business win simultaneous to SOA strategy and action plan. The Dual-Path approach combines the benefits of a quick win with a tactical Web services project with the big picture considerations of SOA. This is important so that any tactical Web services project will fit into the broader SOA strategy and architecture implementation model over time.

Strategic Path

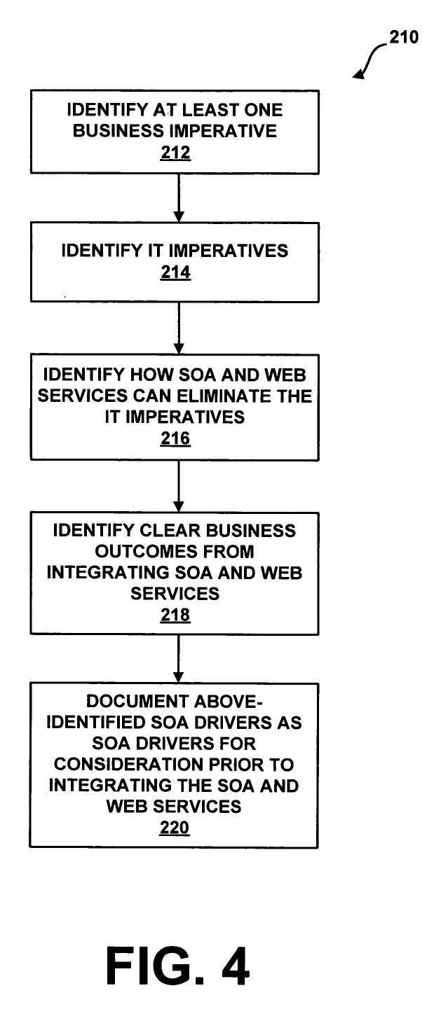

FIG. 3 is a schematic diagram 200 further illustrating steps that may be taken during implementation of the strategic path. A first step that may be taken during use of the strategic path is to identify SOA drivers 210. SOA drivers are matters that are driving the company to understand, plan, design and architect, and implement SOA and Web services into the company. Further illustration of the step of identifying SOA drivers is provided by the schematic diagram of FIG. 4.

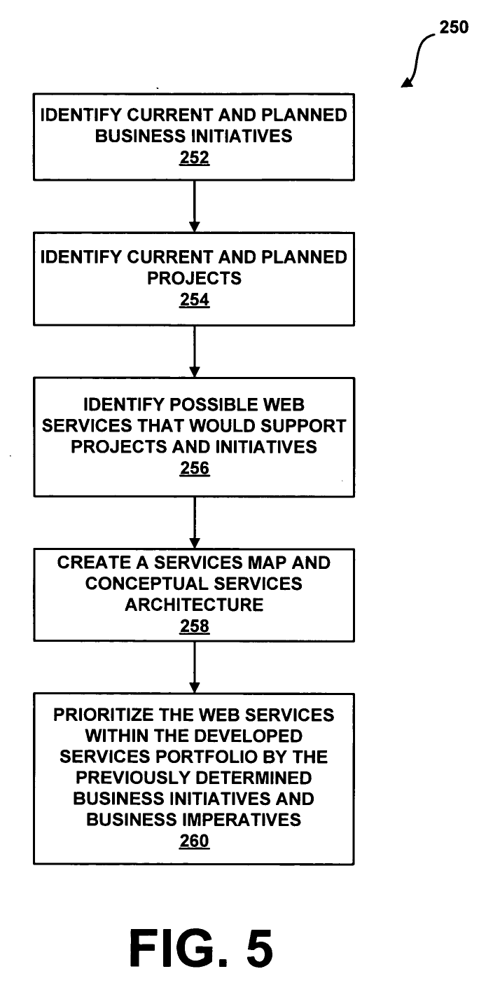

A second step that may be taken during use of the strategic path is to develop a business initiative roadmap 250. The business initiative roadmap, or business services roadmap, is an analysis of the current and planned business initiatives and projects of the company, and an analysis of the current and potential services that will be required to implement or support those business initiatives during the understanding, planning, designing and architecting, and implementation of SOA and Web services. The business initiative roadmap is the sequence of business projects and Web services that will be implemented during some agreed upon time frame within the organization, such as one year, five years, or a different time period. The step of developing a business initiative roadmap is further illustrated by FIG. 5.

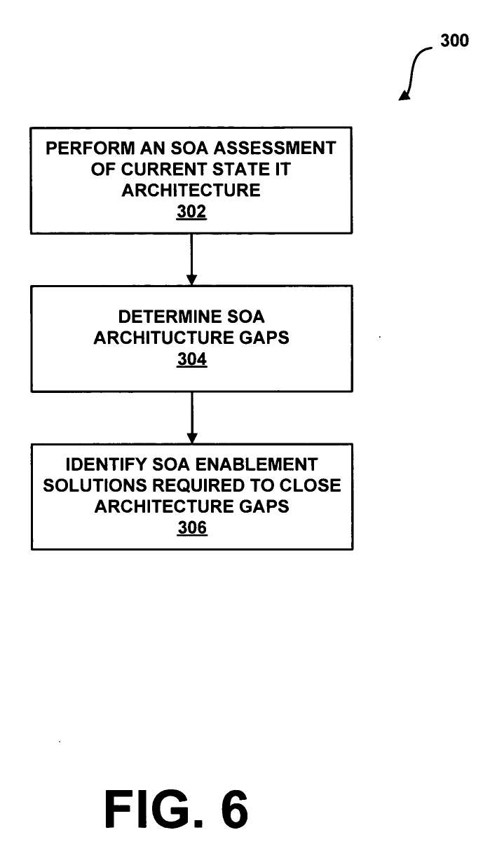

A third step that may be taken during use of the strategic path is to perform an IT architecture assessment 300. Performance of the IT architecture assessment includes performing a review of current IT architecture and needs in the IT architecture for SOA and Web service implementation. The step of performing IT architecture assessment is further illustrated by FIG. 6.

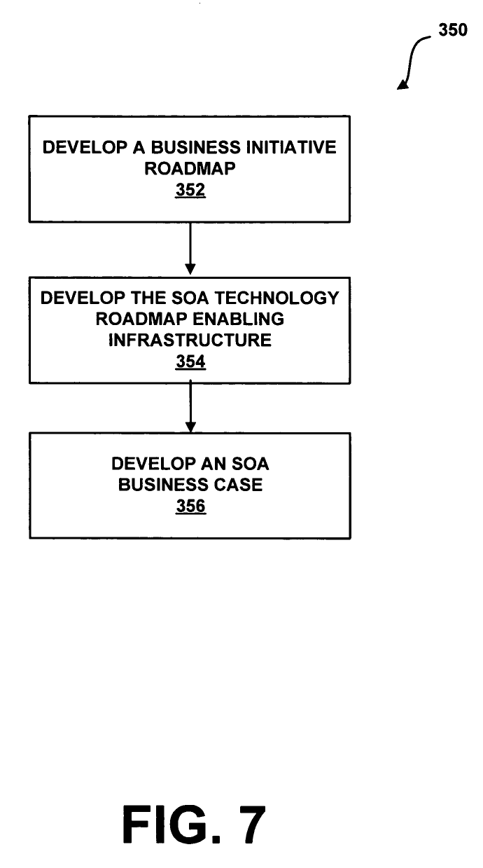

A fourth step that may be taken during use of the strategic path is to develop an SOA technology roadmap 350. The SOA technology roadmap is the result of an analysis of the current IT architecture, applications and platforms, and development tools and solutions of the company. Once the current state IT architecture is understood vis-a-vis the planned business initiatives in the business initiative roadmap, the necessary SOA technical solutions can be implemented to support the business initiative roadmap. The sequence of the SOA enabling technology solutions is called the SOA Technology Roadmap, as it is sequenced to support the Business Initiative Roadmap. The step of developing an SOA technology roadmap 350 is further illustrated by FIG. 7.

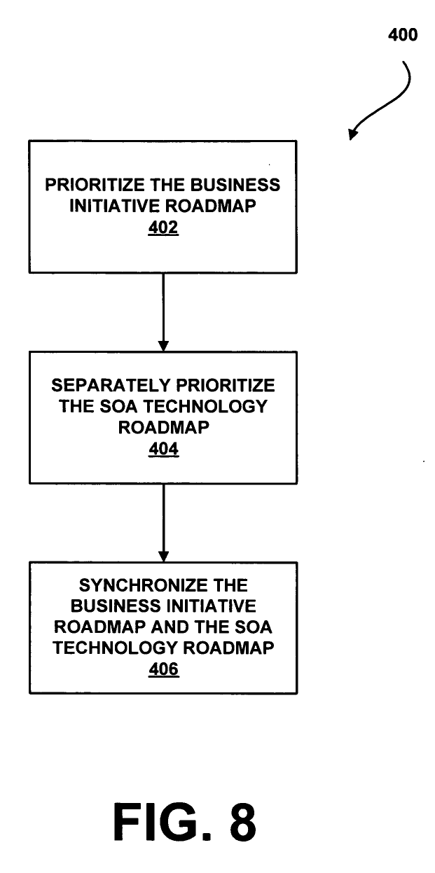

A fifth step that may be taken during use of the strategic path is to prioritize and sequence the business initiative roadmap and the SOA technology roadmap 400. This involves synchronizing the specific business initiatives and Web services initiatives with the implementation of the supporting SOA enabling technology in the SOA technology roadmap. This helps ensure that the specific business initiatives are truly driving the need for SOA technology solutions and not the reverse. This also helps ensure alignment of SOA technologies to business needs and requirements, and creates a business driven SOA process. The step of prioritizing and sequencing SOA technology roadmaps is further illustrated by FIG. 8.

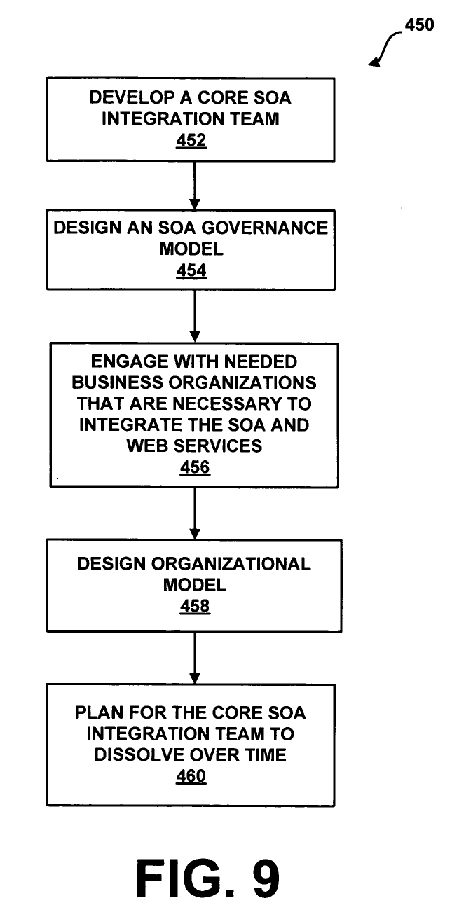

A sixth step that may be taken during use of the strategic path is to develop an SOA governance model and specific governance policies 450. The SOA governance model and policies provide enterprise-wide SOA architectural standards definition, control, and enforcement. SOA governance is for transitioning from point-to-point Web services to reusable business services in an SOA. SOA governance involves defining and implementing the organization, governance processes and procedures, and the necessary governance policies that will be defined and enforced to manage Web services and compliance to the SOA architecture throughout the SOA lifecycle. While governance addresses the organization, processes and required policies for managing the SOA and Web services, the SOA policies are what are enforced at service design, publishing, discovery, invocation, and management. Policies can be business policies, security policies, standards compliance policies such as WS-I or internal standards and other technical policies. The step of developing an SOA governance model and policies is further illustrated by FIG. 9.

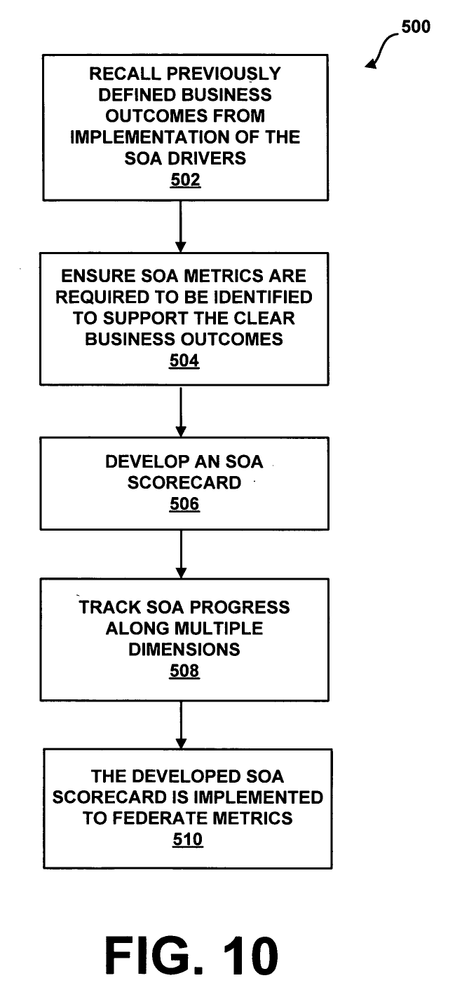

A seventh step that may be taken during use of the strategic path is to develop SOA scorecards and metrics 500. An SOA scorecard is a consulting service and/or a software solution that identifies, relates, and aggregates the necessary SOA metrics into a single visual solution for ongoing management of SOA and Web service efforts of a company. The step of developing SOA scorecards and metrics is further illustrated by FIG. 10.

Identifying SOA Drivers

FIG. 4 is a flowchart further illustrating steps that may be taken in the step of identifying SOA drivers 210. It should be noted that while the following provides a list of steps that may be taken in the step of identifying SOA drivers, the steps need not be limited to the steps listed herein. In addition, all of the steps listed herein need not be considered for each different company, specifically, since different steps may pertain to different companies. However, performing each of the following steps to identify SOA drivers will assist is properly identifying the SOA drivers. It should be noted that identifying SOA drivers results in attaching business context to the SOA and Web services to be integrated in the company. In addition, examples of SOA drivers may include, for example, growing the company, reducing costs, asset re-use, business agility, IT flexibility, time to market, business process improvement, and process visibility and control.

Referring now to FIG. 4, a first step in identifying SOA drivers is to identify at least one business imperative 212. Business imperatives may be any matters that are required to be fixed or implemented by the company for the company to continue function according to a business strategy. As an example, after evaluating company profits over the last five years it may be determined that if sales are not increased this year, the company will loose money this year. Therefore, increasing sales this year would be a business imperative. It would be beneficial to identify at least three business imperatives, although less than three may also be determined.

A second step in identifying SOA drivers is to identify at least one IT imperative 214. Specifically, there may be a number of IT imperatives that are required to be addressed in order to resolve the previously identified business imperatives. In addition, the IT imperatives may not be associated with a specific business imperative. Instead, an IT imperative may simply be an IT matter that is required to be fixed or implemented by the company for the company to function. As an example, the cost structure of IT may be required to be addressed to maintain profitability (e.g., possibly using an outsourcing firm). Alternatively, an IT imperative may be finding a way to integrate with tools used by external partners faster, such as by implementing a new ESB. As an example, a company may use different distribution partners for sales, therefore, when a new distribution partner is considered, a system integration process may be required to use the new distribution partner. This would be an IT imperative due to a lack of providing system integration leading to unwanted delays in distribution. In some cases, the business imperative can be an IT imperative. This would be the case where the SOA initiatives are driven by the IT organization to resolve IT issues.

A third step in identifying SOA drivers is to identify how SOA and Web services can eliminate the IT imperatives 216. Examples of how SOA and Web services can eliminate the IT imperatives may include, but are not limited to, minimizing time to market, adding stability in growth, and providing a different cost structure.

A fourth step in identifying SOA drivers is to identify clear business outcomes from integrating SOA and Web services 218. Specifically, the clear business outcomes that would result from understanding, planning, designing and architecting, and implementing SOA and Web services, in general, are identified. Clear business outcomes derive from the SOA Drivers, business imperatives and IT imperatives above. A clear business outcome is the desired business result expected to be achieved from the SOA and Web services initiatives.

SOA metrics are required to be identified to support the clear business outcomes. As an example, a clear business outcome might be to achieve thirty percent faster time to market for new life insurance products. In order make this clear business outcome measurable, a number of metrics are required to be devised to support the clear business outcome. One metric would be measuring the time to market for life insurance products, which would require measuring the total elapsed time from some trigger event until an ending event, and then finding appropriate ways to track the metric. As such, SOA metrics are the necessary measurements to determine progress toward a business goal. Requirements for SOA metrics are that they are measurable or able to be compared to a standard, and that they can measure the SOA contribution toward achieving a business goal or outcome.

The following provides examples of SOA metrics for exemplary purposes. It should be noted, however, that the following are merely examples, and metrics are not intended to be limited to the examples provided herein. Business metrics may include market share, time to market, cost savings, revenue growth, and customer satisfaction. Process metrics may include process cycle time, process durations, process failures, and a number of process occurrences. Financial metrics may include return on investment (ROI), cost savings, revenue growth, IT budgets, and project costs. Usage metrics may include a number of Web services or other services used, a number of uses for a Web service or other service, a number of users, and a number of services or assets used or re-used. Performance metrics may include how well a process or system is running (e.g., service level agreements (SLA)), contract terms, uptime and downtime metrics, system outages, system failures, and total cycle time. IT efficiency metrics may include asset re-use, services re-use, application development time, application quality, and integration savings. SOA optimization metrics may include a number of services in production, a number of services being reused, and services utilization. SOA governance metrics may include compliance metrics, governance exceptions, and standards conformance.

As will be explained in further detail herein, an SOA scorecard is a consulting service and/or a software solution that identifies, relates, and aggregates necessary SOA metrics into a single visual solution for ongoing management of SOA efforts of an organization. An SOA scorecard can be implemented using a portal, a dashboard Web page, or a business intelligence or analytics framework.

A fifth step in identifying SOA drivers is to document the above-identified SOA drivers (i.e., the business imperatives, the IT imperatives, how SOA and Web services can eliminate the imperatives, and clear business outcomes from SOA and Web) as the SOA drivers for consideration prior to integrating the SOA and Web services 220.

Developing a Business Initiatives Roadmap

FIG. 5 is a flowchart further illustrating the step of developing a business initiative roadmap 250. As is shown by FIG. 5, a first step in developing a business initiative roadmap is to identify current and planned business initiatives 252. For clarity, it should be noted that an imperative is a business condition or issue that is required to be addressed or else the future of the company is at stake, while a business initiative is a high level goal that the company may have to address the imperative. In addition, projects are used to accomplish the business initiative. As an example, an imperative of growing a company may include a merger and acquisition business initiative, which, in turn, may involve multiple projects. An example of one such project may be to perform due diligence on all acquisition targets, while another such project may be to build a general integration architecture for absorbing merger and acquisition targets.

A second step in developing a business initiative roadmap is to identify current and planned projects 254. Further information regarding projects has been provided above.

A third step in developing a business initiative roadmap is to identify possible Web services that would support projects and initiatives 256. The development of a business initiative roadmap also contains the step of creating a services map and conceptual services architecture, the result of which is a developed services portfolio for the company 258. As is shown in further detail below, steps involved in creating a services map include facilitating sessions to identify business processes where SOA and Web services can benefit the company. The following provides examples of steps that may be taken in creating a services map and conceptual services architecture in accordance with a first exemplary embodiment of the invention.

Creating a services map and conceptual services architecture may contain the following steps. A first step may be to develop a value chain for the company. During the step of developing the value chain for the company, a generic value chain is converted into a value chain for a client. A second step performed during creating a services map and conceptual services architecture may be to create a level zero process map. In creating a process map, major business processes relating to the value chain are identified.

As a third step performed during creating a services map and conceptual services architecture, major business initiatives planned in near and medium term may be identified by process areas, after which, the major business initiatives may be linked to processes. Once the value chain of the company has been documented, along with major business processes that map to the value chain (level zero process map), the next step is to identify the opportunities for services across the value chain and business processes. This is best accomplished by identifying major business initiatives and projects that are planned or in progress, and understanding how services support or facilitate these business initiatives and projects. Major business initiatives are broad programs intended to support the business model and corporate strategy of a business model of a company with the intent of improving competitive advantage in measurable terms, such as revenue increase, market share gains, cost reductions, and customer satisfaction. Business initiatives are often very broad and must be divided into multiple projects that altogether will support the major business initiative. Once the business initiatives and projects are identified, it is useful to map these to business process domains and, if possible, specific business processes. This helps to focus the Service Mapping Methodology efforts, as well as to place SOA metrics around the services being implemented to support specific business processes.

A fourth step may be to develop a level zero service map, in which business concept services are identified. Business Concept Services (BCS) are high-level business service descriptions that relate to the business processes identified in the level zero process map. A level zero process map is a high-level summary of major business processes in the organization. Level zero process maps are a basic, linear flow of the key company process activities that result in value being delivered to customers or the goal of the company being accomplished (in the case of non-profits). A level zero process map can be decomposed into level one process maps and level two process maps, depending on how complex various business processes are and how easy they are to depict and document. For the purposes of identifying BCS, the level zero process map is a sufficient starting point. If more process details are needed to develop the BCS, the analysis can proceed to level one and level two process maps as needed. BCS are services concepts that are not technical or even implementable as services yet. They simply relate business processes into business services. To develop a level zero service map a business value chain is developed and an IT value chain is developed. The two value chains are analyzed to identify and segregate “business services” that relate to business process from “technology services” that relate to IT process. While these services will be part of the services portfolio of the company, it may be useful to identify the two types of services initially. Specifically, a business value chain is the flow of business activities that converts inputs into outputs to add value customers. The total cost of the activities in the value chain should not exceed the aggregate price to customers for the company to make a profit. In addition, an IT value chain is the flow of IT activities that convert inputs into outputs to add information value to business customers. The total cost of the IT activities in the value chain should equate to the total of the IT budget of the firm. Documenting and understanding the IT value chain helps identify the IT processes and activities that add value to the business value chain of a company, and can therefore facilitate better optimization of IT processes.

A fifth step in creating a services map and conceptual services architecture may be to identify business and IT services that comprise the level zero service map. As is shown herein, it should be noted that the term “service” is used herein to mean the entire portfolio of services of an SOA, while a portion of the services are Web services.

A sixth step in creating a services map and conceptual services architecture is to develop a level one service map. During development of a level one service map, the identified business concept services are classified into service types (e.g., process services, integration services, coordinator services, information services, and other service types). In addition the scope and functionality of the business concept services are defined at a business requirements and process flow level. Specifically, the business concept services may also be prioritized by business and IT impact, complexity, granularity, and how reusable the business concept services may be. Further, high level functionality may be defined.

A seventh step in creating a services map and conceptual services architecture is to develop a level two service map. During development of the level two service map, implementation of the selected business concept services is defined so as to clarify steps required for implementation of the selected business concepts services. A level two service map results in technical specifications that can be actually implemented by developers when the SOA and services are designed, constructed, tested and put into production.

An eighth step that can be performed in creating a services map and conceptual services is to prioritize BCS by impact and value (business and IT), complexity and re-use. In addition, a ninth step that can be performed in creating a services map and conceptual services is to redraw the business value chain by services.

Returning to FIG. 5, a fourth step in developing a business initiative roadmap is to prioritize the Web services within the developed services portfolio by the previously determined business initiatives and business imperatives 260.

Performing an IT Architecture Assessment

FIG. 6 is a flowchart further illustrating the step of performing an IT architecture assessment 300. As mentioned above, performance of the IT architecture assessment includes performing a review of current IT architecture and needs in the IT architecture for SOA implementation.

As is shown by FIG. 6, a first step in performing the IT architecture assessment is to perform an SOA assessment of current state IT architecture 302. As an example, a team of workers may be assigned to evaluating the IT architecture of the company to determine what IT elements are available in the company and whether they will support an SOA. Examples of such IT elements may include, but are not limited to, hardware, operating systems, application software, application servers and runtime environments, development tools and IDEs, messaging backbones, Enterprise Application Integration (EAI) solutions, single sign-on and security solutions, and modem legacy systems.

A second step in performing the IT architecture assessment is to determine SOA architecture gaps 304. Specifically, a determination is made as to what SOA core solutions are missing from the IT architecture. As was explained previously herein, examples of SOA core solutions may include, but are not limited to, Web services management solutions, services registries, Web services security solutions, and ESBs.

A third step in performing the IT architecture assessment is to identify SOA enablement solutions required to close these gaps 306. Specifically, as an example, if the IT architecture does not have the ability to receive a SOAP message and process the Web services, then this capability should be added in order to run Web services. If the IT architecture does not have a messaging solution in place, then one may be necessary in order to manage the SOAP messages in a reliable fashion, as well as the routing of messages from sender to receiver, as well as from the sender to multiple recipients along a message routing path. There are many such solutions gaps that can be identified in the IT Architecture assessment.

Developing an SOA Technology Roadmap

FIG. 7 is a schematic diagram further illustrating the step of developing an SOA technology roadmap 350. The SOA Technology Roadmap is the result of an analysis of the current IT architecture, applications and platforms, and development tools and solutions of the company. Once the current state IT architecture is understood vis-a-vis the planned business initiatives in the business initiative roadmap, the necessary SOA technical solutions can be implemented to support the business initiative roadmap. The sequence of the SOA enabling technology solutions is referred to herein as the SOA technology roadmap, as it is sequenced to support the business initiative roadmap. A first step in developing an SOA technology roadmap is to develop a business initiative roadmap 352. It should be noted that the step of developing a business initiative roadmap 352 has been described in detail above with reference to FIG. 5. Therefore, further explanation of developing a business initiative roadmap is not provided herein.

A second step in developing an SOA technology roadmap is to develop the SOA technology roadmap enabling infrastructure 354. To develop the SOA technology roadmap enabling infrastructure 354 a determination is made as to the needed SOA enablement solutions. In addition, a determination is made as to the sequence of SOA enablement solution implementation based on the business initiative roadmap. As has been mentioned above, examples of SOA enablement solutions include SOA runtime solutions, Web services management/SOA visibility solutions, service registries, ESB/messaging platform, and Web services security.

Determination of the needed SOA enablement solutions is performed by an analysis of the business initiative roadmap as well as an analysis of the current state IT architecture, gap analysis, and what solutions will close the SOA gap to allow the achievement of the identified business initiatives.

Determination of the sequence of SOA enablement solution implementation based on the business roadmap is performed by an analysis of the business initiative roadmap as well as an analysis if the current state IT architecture, gap analysis, and what solutions will close the SOA gap to allow the achievement of the identified business initiatives. The actual implementation sequence and timing is determined by synchronizing the dual roadmaps (the business initiative roadmap and the SOA technology roadmap).

A third step in developing an SOA technology roadmap is to develop an SOA business case 356. The SOA business case is important for a number of reasons. It helps the company make decisions regarding their desired business initiatives based on the IT and business costs to achieve their desired-business results. It helps in the evaluation of technical alternatives that potentially can be employed to implement the business initiative. It also helps in providing the business metrics and ROI measurements that can be used in the SOA scorecards. It should be noted that a business case is a cost justification for implementing the SOA technology roadmap. As an example, a business case may include hard benefits and soft benefits. Hard benefits include financial benefits that can easily be measured in a bottom line of the company, such as, but not limited to, time to market. Alternatively, soft benefits include benefits that are not easily measured financially, such as, but not limited to, better customer relationships, better employee satisfaction, and a better image to the public (i.e., better brand).

Prioritizing and Sequencing SOA Technology Roadmaps

FIG. 8 is a flowchart further illustrating the step of prioritizing and sequencing SOA technology roadmaps 400. This involves synchronizing the specific business initiatives and Web services initiatives with the implementation of the supporting SOA enabling technology in the SOA technology roadmap. This helps ensure that the specific business initiatives are truly driving the need for SOA technology solutions and not the reverse. Prioritizing and sequencing SOA technology roadmaps 400 also helps to ensure alignment of SOA technologies to business needs and requirements, thereby creating a “business driven SOA process.” A first step in prioritizing and sequencing SOA technology roadmaps is to prioritize the business initiative roadmap (block 402). The business initiative roadmap is the documented set of business initiatives and projects as well as the services opportunities that support them. This could also be described as a “Business Services Roadmap.” The business initiative roadmap should be prioritized such that the sequence of services opportunities identified matches the business priorities of the company, the business model, and corporate strategy. This is what aligns the SOA and services initiatives with the SOA drivers identified above and the business imperatives of the organization. A second step in prioritizing and sequencing SOA technology roadmaps is to separately prioritize the SOA technology roadmap (block 404).

The SOA technology roadmap is the sequence of SOA enabling technology that should be added to the existing IT architecture in support of the business initiative roadmap (or Business Services Roadmap). The SOA technology roadmap should be prioritized primarily by the demands of the business initiative roadmap, and prioritized secondarily by the constraints of the existing IT architecture. While business services and business imperatives are the clear driving force of SOA and services initiatives, the reality of the current state IT architecture also plays a role in what can realistically be implemented to support the company/business. Once the two roadmaps are prioritized, they are synchronized by elapsed time and calendar dates to show how, over short, medium, and long time frames, the business initiative roadmap will be implemented and supported by the SOA technology roadmap. Once this is done, the two roadmaps can be synchronized to ensure that the SOA enabling technology solutions are implemented only when required to support the identified business initiatives in the business initiative roadmap (block 406). For example, one portion of the SOA Technology Roadmap may support multiple business initiatives in the business initiative roadmap. This is why the business initiative roadmap and the SOA technology roadmap are synchronized and continually re-evaluated over time.

Developing an SOA Governance Model and Policies

FIG. 9 is a flowchart further illustrating the step of developing the SOA governance model and policies 450. Basically, development of the SOA governance model and policies is performed to ensure that SOA integration efforts are properly assigned and maintained. The SOA governance model and policies provide enterprise-wide SOA architectural standards definition, control, and enforcement. In other words, the SOA governance model is the overall strategy for managing conformance to the SOA over time. In addition, SOA governance policies are to be implemented and enforced for compliance to SOA standards and design principles.

SOA governance is crucial to transitioning from point-to-point Web services to reusable business services in an SOA. SOA governance involves defining and implementing the company, governance processes and procedures, and the necessary governance policies that will be defined and enforced to manage Web services and compliance to the SOA architecture throughout the SOA lifecycle. While governance addresses the organization, processes and required policies for managing the SOA and Web services, the SOA policies are what are enforced at service design, publishing, discovery, invocation, and management. Policies can be business policies, security policies, standards compliance policies such as WS-I or internal standards and other technical policies.

A first step in developing the SOA governance model and policies is to develop a core SOA integration team 452. Specifically, a determination should be made as to who should be on an SOA integration team. The SOA integration team is an SOA governance organization. Development of the team may include, for example, determining an organizational structure and responsibilities of the participant teams, and individuals within the teams.

A second step in developing the SOA governance model and policies is to design an SOA governance model 454. During designing of the SOA governance model numerous different determinations may be made. As has been mentioned above, the SOA governance model is the overall strategy for managing conformance to the SOA over time. Examples of determinations may include, for example, determining the owner of services to be implemented. In addition determining budgeting, lifecycle support, publishing, and maintenance may be performed. Alternatively, if services to be implemented are not presently owned, the services may be categorized and assigned to a party for ownership, in addition to budgeting for the services.

A third step in developing the SOA governance model and policies is to engage with needed business organizations that are necessary to integrate the SOA and Web services 456. As a fourth step, an organizational model may then be designed 458. As an example, with regard to IT, the IT structure, processes, and roles of individuals involved in the IT structure, may be designed. In addition, with regard to business, the business processes and roles of individuals involved in business processes, may be developed. Further, with regard to governance organization, processes, policies, and metrics may be developed. In addition, proper training and knowledge transfer may be performed.

A fifth step in developing the SOA governance model and policies is to plan for the core SOA integration team to be dissolved over time (block 460). Specifically, as the SOA and Web services are integrated into the company over time, there will be less and less of a need for the SOA integration team. Therefore, the SOA integration team may be dissolved over time.

It should be noted that other steps that may be addressed include determining how governance policies are to be defined, and determining how policies will be communicated, implemented and enforced through the services lifecycle (e.g., SOA governance, Web Services Enablement (development), publishing of developed services to services registries, discovery of services, management of services, and analysis of services performance and SOA metrics via SOA scorecards. In addition, SOA governance model enforcement may be performed, where a determination is made as to whether policies are being adhered to, what policies are not being adhered to, and how often.

Developing SOA Scorecards and Metrics

FIG. 10 is a flowchart further illustrating the step of developing SOA scorecards and metrics 500. As mentioned above, an SOA scorecard is a consulting service and/or a software solution that identifies, relates, and aggregates the necessary SOA metrics into a single visual solution for ongoing management of SOA efforts of an organization. A first step in developing SOA scorecards and metrics is to recall the previously defined business outcomes from implementation of the SOA drivers 502. The business outcomes were identified during identification of the SOA drivers, as described above.

A second step in developing SOA scorecards and metrics is to ensure that SOA metrics are required to be identified to support the clear business outcomes 504. SOA metrics have been discussed herein-above with regard to FIG. 4, and are therefore not further defined here. By considering SOA metrics prior to integration of an SOA and Web services, the integration of the SOA and Web services may be provided in accordance with clear business goals.

A third step in developing SOA scorecards and metrics is to develop an SOA scorecard 506. As has been explained herein-above, an SOA scorecard is a consulting service and/or a software solution that identifies, relates, and aggregates the necessary SOA metrics into a single visual solution for ongoing management of SOA efforts of the company. An SOA scorecard can be implemented using a portal, a dashboard Web page, or a business intelligence or analytics framework.

A fourth step in developing SOA scorecards and metrics is to track SOA progress along multiple dimensions 508. SOA scorecards and metrics are important tools for guiding SOA and services progress for a company. However, a key point for SOA scorecards and metrics is that they are as important before implementation as they are after implementation. The reason for this is that SOA is not implemented in a big bang fashion with a single enterprise-wide project. SOA is realized over a long time frame through multiple SOA and services initiatives that implement the architecture, standards, processes, and enabling technology, through business-driven SOA projects, over time. SOA scorecards and metrics, used in this fashion, help guide SOA progress before, during, and after implementations. SOA scorecards and metrics serve as the SOA compass, helping to keep the SOA progress on track and headed in the proper direction. SOA scorecards and metrics help guide, manage, and measure SOA direction and progress through time. During tracking of SOA progress, different metrics are tracked. As an example, the following may be tracked: business results; ROI; savings; number of services in production; customers; and software assets.

As a fifth step in developing SOA scorecards and metrics, the developed SOA scorecard may be implemented to federate metrics 510. It should be noted that federating metrics means to apply balanced scorecard thinking to the variety of metrics that will be necessary to successfully migrate to manage the success of the SOA being integrated.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method of providing integration of service-oriented architecture (SOA) and Web services into a company, comprising the steps of:
identifying SOA drivers, thereby determining matters that are driving the company to integrate said SOA and Web services into the company;
developing a business initiative roadmap, thereby performing an analysis of current and planned business initiatives and projects of said company, and an analysis of current and potential services that will be required to implement or support said business initiatives during said providing integration of said SOA and Web services;
developing an SOA technology roadmap, thereby determining necessary SOA enabling technical solutions that can be implemented to support said developed business initiative roadmap; and
prioritizing and sequencing said business initiative roadmap and said SOA technology roadmap, thereby synchronizing said business initiatives and Web service initiatives with implementation of said supporting SOA technical solutions determined during said step of developing said SOA technology roadmap.

2. The method of claim 1, further comprising the step of performing an information technology (IT) architecture assessment, thereby performing a review of current IT architecture and needs in said IT architecture for said implementation of said SOA and Web Services.

3. The method of claim 2, wherein said step of performing an IT architecture assessment further comprises the steps of:
performing an SOA assessment of current state IT architecture, thereby determining what IT elements are currently available in said company and whether said IT elements will support said SOA;
determining SOA architecture gaps, thereby determining what SOA core solutions are missing from said IT architecture; and
identifying SOA enablement solutions required to close said architecture gaps.

4. The method of claim 1, wherein said step of identifying SOA drivers further comprises the steps of:
identifying at least one business imperative, wherein said business imperative is required to be fixed or implemented by said company for said company to continue functioning according to a business strategy;
identify at least one IT imperative, wherein said IT imperative is required to be fixed or implemented by said company for said company to continue functioning according to said business strategy;
identifying how SOA and Web services can eliminate said IT imperatives; and
identifying clear business outcomes from integrating said SOA and said Web services, wherein said clear business outcomes are derived from said SOA drivers, said at least one business imperative, and said at least one IT imperative.

5. The method of claim 4, further comprising the step of documenting said identified SOA drivers so that said identified SOA drivers may be considered prior to integrating said SOA and said Web services.

6. The method of claim 4, wherein said step of developing a business initiative roadmap, further comprises the steps of:
identifying current and planned business initiatives, where said business initiatives are high level goals that said company may have to address issues required to be fixed or implemented by said company for said company to continue functioning according to a business strategy;
identifying current and planned projects, where said projects are used to accomplish said business initiatives;
identify Web services that would support said projects and said initiatives; and
creating a services map and conceptual services architecture, resulting in a developed Web services portfolio for said company.

7. The method of claim 6, wherein said step of creating said services map and conceptual services architecture further comprises the steps of:
developing a value chain for said company;
identifying major business processes relating to said value chain;
identifying major business initiatives planned in the near and medium term by process area, after which said major business initiatives are linked to said identified major business processes;
identifying business concept services; and
identifying business and IT services that comprise said business concept service.

8. The method of claim 6, wherein said step of creating said services map and conceptual services architecture further comprises the steps of:
classifying said identified business concept services into service types;
defining implementation of said identified business concept services, thereby clarifying steps required to implement said identified business concept services; and
prioritizing said identified business concept services.

9. The method of claim 8, wherein said step of prioritizing said identified business concept services further comprises the step of prioritizing said identified business concept services by one of a group consisting of impact, value, complexity, and re-use.

10. The method of claim 6, further comprising the step of prioritizing said Web services by said identified business initiatives and said determined business imperatives.

11. The method of claim 1, wherein said step of developing said SOA technology roadmap further comprises the steps of:
developing a business initiatives roadmap;
developing an SOA technology roadmap enabling infrastructure; and
developing an SOA business case.

12. The method of claim 11, wherein said step of developing a business initiative roadmap, further comprises the steps of:
identifying current and planned business initiatives, where said business initiatives are high level goals that said company may have to address issues required to be fixed or implemented by said company for said company to continue functioning according to a business strategy;
identifying current and planned projects, where said projects are used to accomplish said business initiatives;
identify Web services that would support said projects and said initiatives; and
creating a services map and conceptual services architecture, resulting in a developed Web services portfolio for said company.

13. The method of claim 11, wherein said step of developing said SOA technology roadmap enabling infrastructure, further comprises the steps of:
determining needed SOA enablement solutions; and
determining a sequence of SOA enablement solution implementation based on said business initiatives roadmap.

14. The method of claim 11, wherein said step of developing an SOA business case further comprises the step of determining a cost justification for implementing said SOA technology roadmap.

15. The method of claim 1, wherein said step of prioritizing and sequencing said business initiative roadmap and said SOA technology roadmap further comprises the steps of:
prioritizing said business initiative roadmap;
separately prioritizing said SOA technology roadmap; and
synchronizing said business initiative roadmap and said SOA technology roadmap, thereby ensuring that said SOA enabling technology solutions are implemented only when required to support said current and planned business initiatives in said business initiative roadmap.

16. The method of claim 1, further comprising the step of developing an SOA governance model and policies, thereby providing enterprise-wide SOA architectural standards definition, control, and enforcement.

17. The method of claim 16, wherein said step of developing said SOA governance model and policies further comprising the steps of:
designing an SOA governance model;
engaging with needed business organizations that are necessary to integrate said SOA and Web services; and
designing an organizational model.

18. The method of claim 17, further comprising the step of developing a core SOA integration team.

19. The method of claim 18, further comprising the step of planning for said core SOA integration team to dissolve over time.

20. The method of claim 4, further comprising the step of developing SOA scorecards and SOA metrics, thereby providing a visual solution for ongoing management of said SOA and Web services.

21. The method of claim 20, wherein said step of developing said scorecards and metrics further comprising the steps of:
ensuring that said SOA metrics are required to be identified to support said clear business outcomes;
developing said SOA scorecard to identify, relate, and aggregate said SOA metrics into a single visual solution for ongoing management of said integrated SOA and Web services;
tracking progress of an implemented SOA; and
implementing said SOA scorecard.

22. The method of claim 21, wherein said developed SOA scorecard is software.

23. The method of claim 21, wherein said developed SOA scorecard is a consulting service.
